(19) United States
(12) Patent Application Publication
(10) Pub. No.: US 2022/0163403 A1
(43) Pub. Date: May 26, 2022

(54) ISOLATED SINGLE WIRE TEMPERATURE SENSORS

(71) Applicant: FORD GLOBAL TECHNOLOGIES, LLC, Dearborn, MI (US)

(72) Inventor: Larry Dean ELIE, Ypsilanti, MI (US)

(21) Appl. No.: 17/104,112

(22) Filed: Nov. 25, 2020

(51) Int. Cl. G01K 7/04; G01K 1/14; B60R 16/023

(52) U.S. Cl. CPC G01K 7/04; B60R 16/0231; G01K 1/14

(57) ABSTRACT

A system for determining temperature includes a housing having an interior cavity defined by at least one electrically conductive wall having an inside surface exposed to the interior cavity, an outside surface opposite the inside surface, and a single sensor feed through hole defined from the inside surface to the outside surface. A temperature sensor is mounted to the inside surface, including an isolated single wire extending from the sensor to the outside surface via the single sensor feed through hole. The wall provides a first voltage signal responsive to a temperature change within the interior cavity to an electronic device, and the isolated single wire provides a second voltage signal, different from the first, responsive to the temperature change, to the electronic device such that the electronic device determines an interior cavity temperature based on a signal determined from the first and second voltage signals.

### TECHNICAL FIELD

The present disclosure relates to a thermocouple, and more specifically to thermocouple with an isolated single wire feedthrough.

### BACKGROUND

Thermocouples are used across numerous technologies to sense temperature changes within an environment for various purposes, such as reducing the occurrence of thermal events, maintaining or optimizing efficient operation, and controlling other thermal management systems. Conventional thermocouples typically include a two wire design forming an elongated probe in a given environment, with each wire having a different response to the temperature surrounding the wire indicated by a change in electrical property. By connecting the two wires together at a junction, the variable signal output by the wires, in the form of voltage, is detectable and measurable to indicate temperature and variation in temperature in the environment.

Generally, vehicles include various components related to the operation and drivability of the vehicle, which require temperature sensors such as thermocouples to measure temperature within the component environment. For example, vehicle powertrain systems may include thermocouples to monitor temperature within the transmission housing. However, conventional thermocouples require both electrically isolated wires of the probe to feed through the transmission housing to extend out of the other side for connection to an electronic device for measuring the signal developed within the thermocouple probe for calculation of the temperature within the transmission housing. Additional holes for feed throughs, wire sheathing and thermocouple wires themselves result in complex manufacturing.

### SUMMARY

According to an embodiment, a system for determining temperature includes a housing having an interior cavity defined by at least one electrically conductive wall, the electrically conductive wall having an inside surface exposed to the interior cavity, and an outside surface opposite the inside surface. The electrically conductive wall defines a single sensor feed through hole from the inside surface to the outside surface. The system further includes a temperature sensor mounted to the inside surface, the temperature sensor including an isolated single wire extending from the sensor to the outside surface via the single sensor feed through hole. The electrically conductive wall provides a first voltage signal responsive to a temperature change within the interior cavity to an electronic device, and the isolated single wire provides a second voltage signal, different from the first voltage signal, responsive to the temperature change within the interior cavity to the electronic device such that the electronic device determines an interior cavity temperature based on a signal determined from the first and second voltage signals.

According to one or more embodiments, the isolated single wire may be spot-welded to the inside surface to form a thermocouple junction for the temperature sensor. In certain embodiments, the electrically conductive wall may include steel, iron, or aluminum. In at least one embodiment, the isolated single wire may be alumel or chromel. In some embodiments, the isolated single wire may be alumel comprising at least 95% nickel and at least 2% aluminum. In further embodiments, the isolated single wire may be alumel comprising 95% nickel 2% aluminum, 2% manganese and 1% silicon. In other embodiments, the isolated single wire may be chromel comprising 90% nickel and 10% chromium. In one or more embodiments, the signal may be a low voltage signal from 0.005 to 0.5 V. In certain embodiments, the housing may be a vehicle component housing. In further embodiments, the vehicle component housing may be an engine case or a transmission case.

According to another embodiment, a vehicle component thermal management system includes a housing having an interior cavity defined by at least one electrically conductive wall, with the electrically conductive wall having an inside surface exposed to the interior cavity, and an outside surface opposite the inside surface and on an external side of the housing. The vehicle component thermal management system also includes a temperature sensor mounted to the inside surface, the temperature sensor including an isolated single wire extending from the sensor to the outside surface via a feed through hole defined in the housing, the isolated single wire being made of a material dissimilar from the electrically conductive wall, and an electronic device electrically connected to the isolated single wire and the housing on the external side. Responsive to a temperature change within the interior cavity, the electrically conductive walls provide a first voltage signal to the electronic device, and the isolated single wire provides a second voltage signal to the electronic device such that the electronic device compares the first and second voltage signals to reference voltages corresponding to predetermined temperatures and determines an interior cavity temperature based on a signal determined from the first and second voltage signals.

According to one or more embodiments, the isolated single wire may be spot-welded or friction stir welded to the inside surface to form a thermocouple junction for the temperature sensor. In at least one embodiment, the electrically conductive wall may include steel or aluminum. In certain embodiments, the isolated single wire may be alumel comprising at least 95% nickel and at least 2% aluminum. In some embodiments, the isolated single wire may be alumel comprising 95% nickel 2% aluminum, 2% manganese and 1% silicon. In other embodiments, the isolated single wire may be chromel comprising 90% nickel and 10% chromium. In one or more embodiments, the signal may be a low voltage signal from 0.005 to 0.5 V.

According to yet another embodiment, a vehicle component thermal management system includes an electrically conductive housing having walls with an inside surface defining an interior cavity, and the housing defining a feed through hole in a wall and sized to receive a single thermocouple wire therethrough. The vehicle component thermal management system further includes a temperature sensor in the interior cavity, with the temperature sensor including an isolated single wire having a first end region spot-welded to the inside surface, and a second end region extending outwardly through the feed through hole and positioned external to the housing. The system also includes an electronic device configured to receive a first voltage signal from the electrically conductive housing and a second voltage signal from the temperature sensor. In response to a temperature change within the interior cavity, the second voltage signal is different from the first voltage signal. The electronic device compares the first and second voltages to reference voltages to determine a voltage difference corresponding to predetermined temperatures such that the electronic device determines an interior cavity temperature.

According to one or more embodiments, the electrically conductive housing may be a transmission or engine case. In at least one embodiment, the isolated single wire may be alumel, or chromel.

### BRIEF DESCRIPTION OF THE DRAWINGS

FIG. 1 is a schematic diagram of a vehicle;

FIG. 2 is a schematic diagram of a vehicle component with a conventional two-wire thermocouple;

FIG. 3 is a schematic diagram of a vehicle component with an isolated single wire thermocouple, according to an embodiment; and

FIG. 4 is a graph showing the signal voltage for a chromel isolated single wire thermocouple, according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary, the description of a group or class of materials by suitable or preferred for a given purpose in connection with the disclosure implies that mixtures of any two or more members of the group or class may be equally suitable or preferred.

Thermocouples rely on the Seebeck effect to sense temperature changes within their environment. The Seebeck effect relates electric potential to a temperature gradient across different materials. Generally, a change in temperature from one side of the thermocouple to the other side generates a potential difference resulting in electric current through the wires such that voltage at an end of the thermocouple is measured by an electronic device for conversion to temperature given the material properties of the wires of the thermocouple. Vehicle components include thermocouples as temperature sensors, and in certain sealed environments, require feed throughs for connecting the thermocouple to the electronic device.

According to one or more embodiments, a single-wire thermocouple is provided for a vehicle component such that a single feedthrough is required to measure the voltage at the junction on the inside of the component housing. Although the single-wire thermocouple generates a lower signal than conventional two-wire thermocouples, the signal is still measurable for detecting temperature within the component housing without requiring additional wire material, wire insulation, or feedthrough holes in the housing.

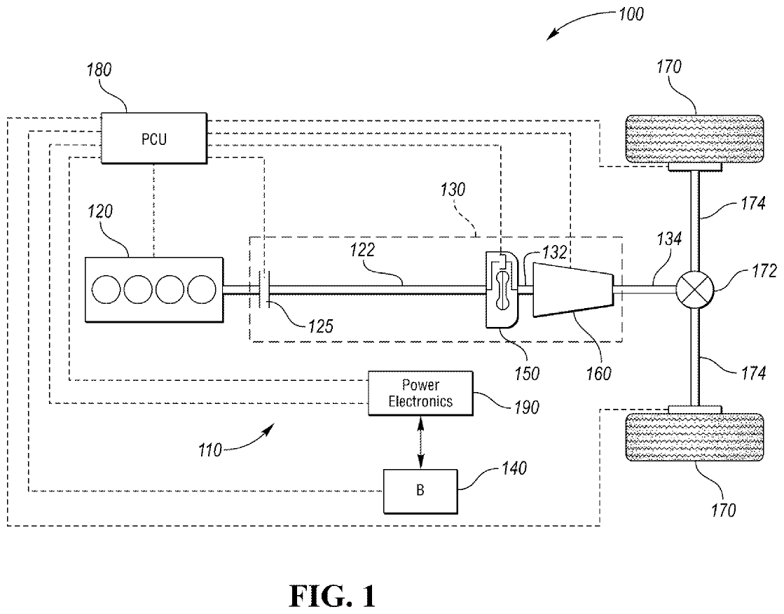

Referring to FIG. 1, a schematic diagram representative of a vehicle 100 having a vehicle powertrain system 110 is illustrated. The powertrain system 110 includes various power generating components (i.e., engines or electric motors) and the drivetrain (not shown). The drivetrain is the group of components that deliver power to the driving wheels, excluding the power generating components. In contrast, the powertrain 110 includes both the power generating components and the drivetrain. As shown in FIG. 1, the powertrain 110 includes an engine 120 and a transmission 130. The engine 120 generally represents a power source that may include an internal combustion engine such as a gasoline, diesel, or natural gas powered engine, or a fuel cell. The vehicle 100 may also include components such as, but not limited to, a traction battery 140, a torque converter 150, and a multiple step-ratio automatic transmission, or gearbox 160. The transmission 130 may include a planetary gear set which may be configured to provide multiple gear ratios between an input and an output of the transmission 130. The engine 120 may be connected to the input 132 of the transmission 130 in any suitable manner, such as by a clutch 125. The torque converter 150 thus provides a hydraulic coupling between shaft 122 and transmission input shaft 132. The engine 120 is connected to the input 132 of the transmission 130 from the torque converter 150 via the shaft 122. The gearbox 160 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between the transmission output shaft 134 and the transmission input shaft 132. The gearbox 160 is automatically shifted from one ratio to another based on various vehicle and ambient operating conditions by an associated controller, such as a powertrain control unit (PCU) 180. The gearbox 160 then provides powertrain output torque to the transmission output shaft 134. It should be understood that the hydraulically controlled gearbox 24 used with a torque converter 22 is but one example of a gearbox or transmission arrangement; any multiple ratio gearbox that accepts input torque(s) from an engine and/or a motor and then provides torque to an output shaft at the different ratios is acceptable for use with embodiments of the present disclosure. For example, gearbox 24 may be implemented by an automated mechanical (or manual) transmission (AMT) that includes one or more servo motors to translate/rotate shift forks along a shift rail to select a desired gear ratio.

The drivetrain components that are configured deliver power to wheels 170 are connected to an output shaft 134 of the transmission 130. The transmission output shaft 134 is connected to a differential 172. The differential 172 drives a pair of wheels 170 via respective axles 174 connected to the differential 172. The differential transmits approximately equal torque to each wheel 170 while permitting slight speed differences such as when the vehicle turns a corner. Different types of differentials or similar devices may be used to distribute torque from the powertrain to one or more wheels. In some applications, torque distribution may vary depending on the particular operating mode or condition, for example. It should further be understood that although a rear wheel drive configuration is depicted herein, other powertrain/drivetrain configurations are also contemplated. Other powertrain/drivetrain configurations may include, but are not limited to, front wheel drive powertrains/drivetrains, all-wheel drive powertrains/drivetrains, powertrain/drivetrain configurations that are capable of transitioning between two-wheel and four-wheel drive modes, or any other powertrain/drivetrain configuration known to a person of ordinary skill in the art.

Referring again to FIG. 1, the powertrain control unit (PCU) 180, while illustrated as one controller, may be part of a larger control system and may be controlled by various other controllers throughout the vehicle 100, such as a vehicle system controller (VSC). It should therefore be understood that the powertrain control unit 180 and one or more other controllers can collectively be referred to as a “controller” that controls various actuators in response to signals from various sensors to control functions such as starting/stopping engine 14, select or schedule transmission shifts, manage temperature within the powertrain via thermal management systems, etc. Controller 180 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller 180 communicates with various engine/vehicle sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 1, PCU 180 may communicate signals to and/or from engine 120, clutch 125, battery 140 transmission 130, gearbox 160, and power electronics 190. Although not explicitly illustrated, those of ordinary skill in the art will recognize various functions or components that may be controlled by PCU 180 within each of the subsystems identified above. Representative examples of parameters, systems, and/or components that may be directly or indirectly actuated using control logic executed by the controller include fuel injection timing, rate, and duration, throttle valve position, spark plug ignition timing (for spark-ignition engines), intake/exhaust valve timing and duration, front-end accessory drive (FEAD) components such as an alternator, air conditioning compressor, battery charging, regenerative braking, M/G operation, clutch pressures for disconnect clutch 26, launch clutch 34, and transmission gearbox 24, and the like. Sensors communicating input through the I/O interface may be used to indicate turbocharger boost pressure, crankshaft position (PIP), engine rotational speed (RPM), wheel speeds (WS1, WS2), vehicle speed (VSS), coolant temperature (ECT), intake manifold pressure (MAP), accelerator pedal position (PPS), ignition switch position (IGN), throttle valve position (TP), air temperature (TMP), exhaust gas oxygen (EGO) or other exhaust gas component concentration or presence, intake air flow (MAF), transmission gear, ratio, or mode, transmission oil temperature (TOT), transmission turbine speed (TS), torque converter bypass clutch status (TCC), or shift mode (MDE), for example.

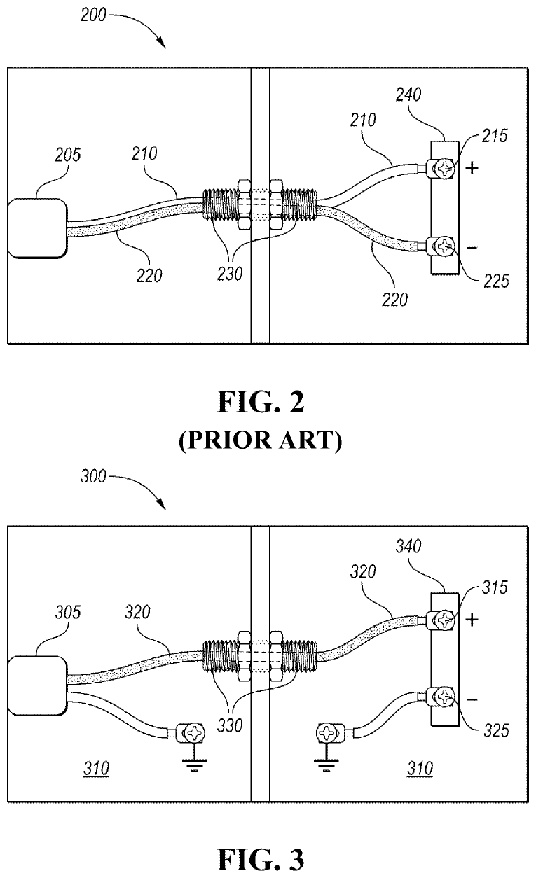

Components such as the engine 120 and the transmission 130 include housings for the equipment. The housings may be monitored by a thermal management system which includes thermal sensors and electronic devices such as a processor and a controller for receiving and calculating inputs from the thermal sensors, and for sending output signals to thermal management devices such as blowers, fans, or heaters for adjusting the temperature within the component housing. The thermal sensors included in the vehicle components are conventionally two wire thermocouples, as shown schematically in FIG. 2, with the thermocouple 200 including a junction 205 for measuring temperature via first wire 210 and a second wire 220 through the feedthrough housing 230, with the wires 210, 220 having the electrical current measured at junction points at an electronic device 240, with one wire being connected at positive terminal 215 and the other at negative terminal 225.

Referring to FIG. 3, a vehicle component 301 having an isolated single wire temperature sensor 300 is shown. The vehicle component includes a housing 350 having a surface 310 including a single feed through 330 such that the isolated single wire 320 of the temperature sensor 300 can extend out from the inside of the housing to the outside. The surface 310 forming the interior of housing 350 may be made of any electrically conductive material, such as, but not limited to, steel (e.g., cold rolled 1018 steel). It is further contemplated that a Type J arrangement (Iron/Constantan), or an aluminum material for the surface 310 may be interchangeable with the steel constantan arrangement with one wire and the housing material surface, and any discussion of particular material selection is not intended to be limiting. The isolated single wire temperature sensor 300 includes a junction 305 on the inside surface 310 of the housing 350, which may be formed by spot-welding an end of the isolated single wire 320 to the housing. In embodiments where the surface 310 is an electrically conductive material other than steel, such as, for example, aluminum, spot-welding aluminum may include additional steps such as, but not limited to, sanding or abrading the aluminum oxide layer in an inert atmosphere and then doing the spot weld in that inert atmosphere. In other embodiments, friction stir welding in an inert atmosphere may also be used in place of spot-welding for materials other than steel. The isolated single wire 320 is insulated except for at the spot-weld to the housing 350, and then run along the housing 350 and out through the feed through 330 such that it is connected to an electronic device 340 (for example, PCU 180) for reading the signal through the wire 320. The wire 320 may be floating or have resistive reference to ground, according to any suitable arrangement. The electronic device 340 is also connected to the surface 310 of the housing 340 (i.e., the electrically conductive material), such that a reading is available from the housing material as well, thus the dissimilar materials providing the thermocouple type affect include the isolated single wire temperature and the housing structure itself. Thus, temperature changes within the housing cause the potential across the isolated single wire and housing to change, generating a signal (e.g., voltage signal) which can be measured at the electronic device and compared with reference voltages from a calibration to determine the signal or a voltage difference corresponding to a change in the temperature of the interior cavity.

In certain embodiments, on the outside of the housing, an identical type of bond (e.g., a spot-weld) may be made to the same isolated single wire material to the outside of the housing. Where the housing material provides a homogenous structure, and the temperature gradient across the surface of the housing is constant, the additional junctions cancel each other out for measurement purposes at the electronic device.

The signal received from single-wire temperature sensor arrangement with the housing is calibrated for the voltage it provides at given temperatures, such that the electronic device can process the voltage provided by the signal, and determine the temperature at the internal junction within the housing. The calibration allows for measurement of voltage as a function of temperature. In some embodiments, the isolated single wire may be calibrated with the housing structure at the normal operating temperature range, similar to using a new reference junction of a two-wire system. With this set up, an isolated single wire now provides a reasonable accurate representation of the correct temperature of the internal junction, at a lower but easily measured signal voltage.

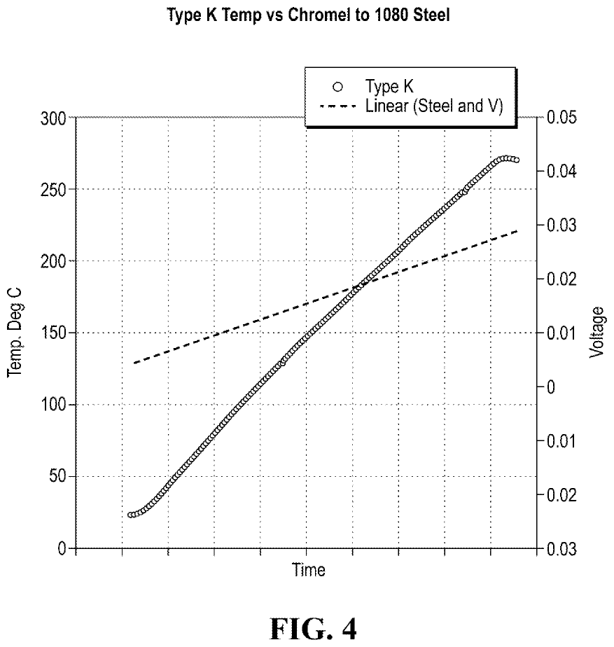

Although different material options are available for thermocouples, only certain materials provide high signals without corrosion at high temperature, and certain materials are available at lower cost. Other materials could be used in conventional thermocouple applications, but they generally have very poor signal strength, as shown by their Seebeck coefficients, so higher signal materials are conventionally chosen to be paired for a given temperature range. A conventional thermocouple example is a Type K thermocouple, which includes a nickel-chromium wire and a nickel-alumel wire. Although Type K materials are conventionally inexpensive and used for a high signal in two-wire thermocouples, alumel and chromel wires, as well as other thermocouple materials can be used as an isolated single wires to output lower range signals as paired with any dissimilar electrically conductive material housing (e.g., steel or iron), without incurring the costs of wire material, additional feed throughs, and efficiency. The signal detected for an isolated single wire temperature sensor may be ¼ to ⅔ of the similar material two wire system, such as a Type K thermocouple for the example shown in FIG. 4, or in other embodiments ⅓ to ½ of the signal, or in yet other embodiments, ⅓ of the signal. In one or more embodiments, the signal provided from the isolated single wire temperature sensor may be from 0.005 to 0.5 V in some embodiments, 0.01 to 0.45 in other embodiments, and 0.01 to 0.40 V in yet other embodiments. In other embodiments, the signal provided from the isolated single wire temperature sensor may be from 0.005 to 0.05 V in some embodiments, 0.01 to 0.045 in other embodiments, and 0.01 to 0.04 V in yet other embodiments. However, the system may be calibrated based on the materials chosen, and, in some circumstances, for the path length of the signal. In the examples below, the length of the wire and path length over the electrically conductive wall may provide a certain signal, e.g., 0.4 V for a 3 ft. long chromel wire and a path length of 2 ft. for the electrically conductive housing signal. If the path length increases, the calibration must be modified even though the materials have not changed because of the thermocouple junction ability to source current over a given path length. The system will have a valid calibration if these factors are considered. As such, the system requires calibration using the isolated single wire and chosen voltage path length for the reference material as well as having chosen a location on the electrically conductive wall that has a relatively stable temperature.

In at least one embodiment, the isolated single wire of the thermocouple may be an alumel wire. Alumel is an alloy material including nickel and aluminum. An alumel wire may include other elements such as, but not limited to manganese and silicon. In one or more embodiments, the alumel wire is comprised of at least 95% nickel and at least 2% aluminum. In certain embodiments, the alumel includes 95% nickel 2% aluminum, 2% manganese and 1% silicon. When the alumel wire is set as the negative lead and the steel is set as the positive lead, the electronic device outside the housing can receive a low signal which can be processed to determine temperature or change in temperature within the housing.

In at least one other embodiment, the isolated single wire of the thermocouple may be a chromel wire. Chromel is an alloy material including chromium and nickel. A chromel wire may include other elements, and any suitable alloy is contemplated. In one or more embodiments, the chromel wire is comprised of 90% nickel and 10% chromium. When the chromel wire is set as the negative lead and the steel is set as the positive lead, the electronic device outside the housing can receive a low signal which can be processed to determine temperature or change in temperature within the housing. An example of the signal of a single chromel wire spot welded to a 1/32″ diameter steel wire 1 meter long is provided in FIG. 4, where, although the signal range is low, the change in signal is clear over temperature, and is thus measurable with only an isolated single wire.

As such, according to one or more embodiments, an isolated single wire temperature sensor is included on the inside of a vehicle component housing such that the temperature inside the housing can be accurately determined using only an isolated single wire feed through. The isolated single wire of the is bonded (e.g., via spot welds) at the thermocouple junction to the conductive housing, and insulated to pass out of the feed through of the housing.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for determining temperature comprising:
a housing having an interior cavity defined by at least one electrically conductive wall, the at least one electrically conductive wall having an inside surface exposed to the interior cavity, an outside surface opposite the inside surface, and defining a single sensor feed through hole from the inside surface to the outside surface; and
a temperature sensor mounted to the inside surface, the temperature sensor including an isolated single wire extending from the sensor to the outside surface via the single sensor feed through hole,
wherein the at least one electrically conductive wall provides a first voltage signal responsive to a temperature change within the interior cavity to an electronic device, and the isolated single wire provides a second voltage signal, different from the first voltage signal, responsive to the temperature change within the interior cavity to the electronic device such that the electronic device determines an interior cavity temperature based on a signal determined from the first and second voltage signals.

2. The system of claim 1, wherein the isolated single wire is spot-welded or friction stir welded to the inside surface to form a thermocouple junction for the temperature sensor.

3. The system of claim 1, wherein the at least one electrically conductive wall includes steel, iron, or aluminum.

4. The system of claim 1, wherein the isolated single wire is alumel or chromel.

5. The system of claim 4, wherein the isolated single wire is alumel comprising at least 95% nickel and at least 2% aluminum.

6. The system of claim 4, wherein the isolated single wire is alumel comprising 95% nickel 2% aluminum, 2% manganese and 1% silicon.

7. The system of claim 4, wherein the isolated single wire is chromel comprising 90% nickel and 10% chromium.

8. The system of claim 1, wherein the signal is a low voltage signal from 0.005 to 0.5 V.

9. The system of claim 1, wherein the housing is a vehicle component housing.

10. The system of claim 9, wherein the vehicle component housing is an engine case or a transmission case.

11. A vehicle component thermal management system comprising:
a housing having an interior cavity defined by at least one electrically conductive wall, the at least one electrically conductive wall having an inside surface exposed to the interior cavity, and an outside surface opposite the inside surface and on an external side of the housing;
a temperature sensor mounted to the inside surface, the temperature sensor including an isolated single wire extending from the sensor to the outside surface via a feed through hole defined in the housing, the isolated single wire being made of a material dissimilar from the at least one electrically conductive wall; and
an electronic device electrically connected to the isolated single wire and the housing on the external side,
wherein responsive to a temperature change within the interior cavity, the electronic device receives a first voltage signal from the at least one electrically conductive wall, and a second voltage signal from the isolated single wire such that the electronic device compares the first and second voltage signals to reference voltages to determine a voltage difference corresponding to predetermined temperatures and determines an interior cavity temperature based on the voltage difference.

12. The vehicle component thermal management system of claim 11, wherein the isolated single wire is spot-welded or friction stir welded to the inside surface to form a thermocouple junction for the temperature sensor.

13. The vehicle component thermal management system of claim 11, wherein the at least one electrically conductive wall includes steel, iron, or aluminum.

14. The vehicle component thermal management system of claim 11, wherein the isolated single wire is alumel comprising at least 95% nickel and at least 2% aluminum.

15. The vehicle component thermal management system of claim 11, wherein the isolated single wire is alumel comprising 95% nickel 2% aluminum, 2% manganese and 1% silicon.

16. The vehicle component thermal management system of claim 11, wherein the isolated single wire is chromel comprising 90% nickel and 10% chromium.

17. The vehicle component thermal management system of claim 11, wherein the isolated single wire is alumel or chromel and the signal is a low voltage signal from 0.005 to 0.5 V.

18. A vehicle component thermal management system comprising:
an electrically conductive housing having walls with an inside surface defining an interior cavity, and defining a feed through hole in a wall and sized to receive a single thermocouple wire therethrough;
a temperature sensor in the interior cavity, the temperature sensor including an isolated single wire having a first end region spot-welded to the inside surface, and a second end region extending outwardly through the feed through hole and positioned external to the housing; and
an electronic device configured to receive a first voltage signal from the electrically conductive housing and a second voltage signal from the temperature sensor, wherein, in response to a temperature change within the interior cavity, the second voltage signal is different from the first voltage signal, and wherein the electronic device compares the first and second voltages to reference voltages to determine a voltage difference corresponding to predetermined temperatures such that the electronic device determines an interior cavity temperature.

19. The vehicle component thermal management system of claim 18, wherein the electrically conductive housing is a transmission or engine case.

20. The vehicle component thermal management system of claim 18, wherein the isolated single wire is alumel or chromel.
